(19) United States
(12) Patent Application Publication
(10) Pub. No.: US 2005/0042426 A1
(43) Pub. Date: Feb. 24, 2005

(54) Image-recording sheet

(76) Inventors: Koji Kamiyama, Tama-city (JP); Shigeaki Dohgoshi, Tokyo (JP)

Correspondence Address: 3M INNOVATIVE PROPERTIES COMPANY, PO BOX 33427, ST. PAUL, MN, 55133-3427, US

(21) Appl. No.: 10/492,268

(22) PCT Filed: Sep. 20, 2002
(86) PCT No.: PCT/US02/29955

(30) Foreign Application Priority Data
Nov. 16, 2001 (JP) 2001-351009

(51) Int. Cl. B41M 5/00

(52) U.S. Cl. 428/195.1

(57) ABSTRACT

In an image-recording sheet comprising a paper substrate and an image-recording layer formed on at least one surface of the paper substrate, the image-recording layer contains a white pigment, an aqueous binder resin, and a compatibilizer.

### BACKGROUND OF THE INVENTION

1. Technical Field

The present invention relates to an image-recording sheet to be used with image-forming equipment such as an electrophotographic color copying machine or a color printer. In particular, the present invention relates to an image-recording sheet on which a color toned image can be thermally fixed.

2. Background

Electrophotography is a general term of image-recording systems using photoelectric phenomena and static electricity and generally comprises the following general steps. A photoconductive layer made of a photosemiconductor is pre-charged with static electricity to make it photosensitive. Next, a camera is used to project an image onto the photoconductive layer. The electric charge in the light areas of the image is eliminated to form an electrostatic latent image on the photoconductive layer. A coloring fine particle (which may be called a “toner”) having an electric charge opposite to that of the electrostatic latent image is adhered to the photoconductive layer to develop the electrostatic latent image and to form a toned image. The toned image is transferred to an image-recording sheet with a transfer roll. The toned image is fixed, e.g., using a thermally fixing apparatus. Recently, after latent images are formed for respective color-separated light ray and the respective electrostatic latent images are developed using color toners to obtain toned images and the color image is formed on the image-recording sheet.

Most of the image-recording sheets comprise a recording layer formed on a substrate and the above described toned image is fixed to the recording layer. For example, JP-A-63-92965 and JP-A-11-160905 disclose an image-recording sheet comprising a paper substrate and a recording layer of a transparent resin formed on the paper substrate. The gloss of the images formed on the recording sheet is improved with the decrease of the surface unevenness by burying the toner in the recording layer in the course of thermal fixing.

In the image-recording sheet disclosed in the above patent publications, when the toner is provided on the image-recording layer at a high concentration, a plurality of toner particles are laminated in several layers. Thus, sometimes it is difficult to bury all the toner particles completely. As a result, the toner particles tend to protrude over the image-recording layer and scatter light to deteriorate the gloss of the color images. Accordingly, the image-recording sheet disclosed in the above patent publications may not necessarily be advantageous for displaying imaged information such as photographs.

The image-recording layer of the above-described image-recording sheet contains a fairly large amount of a binder resin to prevent the decrease of the gloss of the image. However, the binder resin tends to decrease the gas permeability of the image-recording layer. As a result, the image-recording sheet tends to form blisters in the course of thermal fixing. That is, the surface of the image-recording sheet is easily roughened leading to delamination of the layers caused by the thermal expansion of moisture contained in the paper substrate or the image-recording layer. Such a roughened surface is undesirable from the viewpoint of the image quality.

Thus, as described in JP-B-5-82940, the formation of blisters in the image-recording sheet is suppressed by forming an image-recording layer, in which a pigment having an average particle size of 1.5 μm or less is used in a coating layer, a center line average surface roughness of the coating layer is 2 μm or less, and a gas permeability of the coating layer is 4,000 seconds or less. However, this image-recording sheet can record only images with a certain gloss because the surface of the toned image is roughened when toners for low gloss finishing are used. As a result, the gloss of the toned image is lowered due to light scattering. Therefore, this image-recording sheet may not necessarily be advantageous for displaying the imaged information.

### SUMMARY

The present provides an image-recording sheet capable of easily recording an image with a gloss of a desired level regardless of the kinds of toners used. In brief summary, the present invention provides an image-recording sheet comprising a paper substrate and an image-recording layer formed on at least one surface of the paper substrate. The image-recording layer comprises a white pigment, an aqueous binder resin, and a compatibilizer.

### BRIEF DESCRIPTION OF THE DRAWINGS

The invention will be frther explained with reference to the following drawing, wherein:

FIG. 1 is a cross-section of one embodiment according to the present invention.

This FIGURE is idealized, not drawn to scale, and is intended to be merely illustrative and non-limiting.

### DETAILED DESCRIPTION

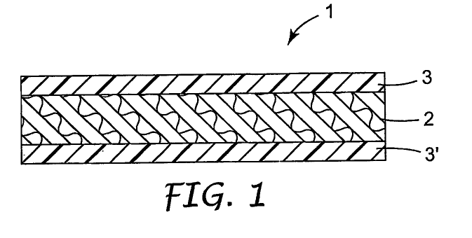

FIG. 1 is a cross section of one preferred embodiment of the recording sheet for electrophotography according to the present invention. Recording sheet 1 comprises paper substrate 2, and image-recording layers 3, 3′ which are formed on the respective surfaces of paper substrate 2.

In general, paper substrate 2 is in close contact with the image-recording layers and supports them. The kind of the paper substrate useful for this invention is not limited as long as it can be in close contact with the image-recording layer(s). For example, the paper substrate may be formed of non-coated paper such as fine quality paper, medium quality paper, etc. Alternatively, the paper substrate may be formed of a coated paper such as enamel paper, art paper, synthetic paper, etc. Preferably, the basis weight of the paper substrate is within a range of 60 to 230 kg/m². When the basis weight is less than 60 kg/m², the stiffness of the paper substrate is weak and its transportability in the image-recording equipment may be worsened. When the basis weight exceeds 230 kg/m², the amount of heat necessary to sufficiently melt the toners in the thermal fixing step may be insufficient and the gloss tends to be lowered.

On the both surfaces of paper substrate 2, image-recording layers 3,3′ each having a dry coated weight of 1.0 to 30.0 g/m² are provided by, for example, coating. These layers make it possible to receive the toned image by thermal fixing. The image-recording layer contains a white pigment, which imparts gas permeability to the layer to suppress the blisters. In particular, when the white pigment has an average particle size of 0.01 to 2 μm, the blisters can be effectively prevented, and also the gloss of the image-recording can be improved. As a result, the color images with high quality can be formed on the image-recording sheet. Examples of the white pigment useful in the present invention include kaolin, heavy calcium carbonate, precipitated calcium carbonate, barium sulfate, titanium dioxide, titanium white, talc, plastic pigments, etc. They may be used singly or in admixture of two or more. Preferably, the white pigment is used in an amount of 50 to 90 wt. parts per 100 wt. parts of the image-recording layer.

The white pigment is bound with an aqueous binder resin. The aqueous binder resin is advantageous because it can effectively adhere to the paper substrate with low blocking properties. Herein, the “aqueous binder resin” means a resin which is dispersible or soluble in water.

Examples of the aqueous binder resin include polyurethane resins, polyester resins, styrene-butadiene resins, styrene-acrylate resins, acrylic resins, etc. These resins are particularly preferable because they can provide high surface gloss to the image-recording sheet. Preferably, the aqueous binder resin is contained in an amount of 5 to 25 wt. parts per 100 wt. parts of the image-recording layer. When the amount of the aqueous binder resin is less than 5 wt. parts, the strength of the layer decreases. When the amount of the aqueous binder resin exceeds 25 wt. parts, the gas permeability of the layer increases to cause blisters.

According to the present invention, the image-recording layer further contains a compatibilizer. The compatibilizer facilitates the melting of the toners in the thermal fixing step. It improves the compatibility of the toners to each other and also the compatibility of the toners with the aqueous binder resin in the recording layer. As a result, the images with high smoothness and high gloss can be formed on the inventive image-recording sheet. High gloss is possible because of the suppression of light scattering. The degree of gloss does not depend on the kind of the toner, and can be made high even with a toner which is designed for low gloss image (e.g., Toner EP-83 special for Color Laser Shot available from Canon). Thus, the use of the compatilizer is advantageous for the effective display of the imaged information.

Preferably, the compatibilizer has a solubility parameter (SP value) of 8.0 to 10.0, because such a solubility parameter has good compatibility with the toners and thus allows for the effective melting of the toners. Herein, the solubility parameter is calculated by the method disclosed in P. A. Small, J. Appl. Chem., 3:71, 1953. The solubility parameter of dibutoxyethoxyethyl adipate is 8.7 according to this method.

Other examples of the preferable compatibilizer include polyalkylene glycol esters (e.g., polyethylene glycol dibenzoate; polypropylene glycol dibenzoate; dipropylene glycol dibenzoate; diethylene/dipropylene glycol dibenzoate; polyethylene glycol dioleate; polyethylene glycol monolaurate; polyethylene glycol monooleate; triethylene glycol bis(2-ethylhexanoate); and triethylene glycol caprate-caprylate). Alkyl esters, substituted alkyl esters and aralykl esters also act as compatibilizers including triethyl citrate; tri-n-butyl citrate, acetyltriethyl citrate; dibutyl phthalate; diethyl phthalate; dimethyl phthalate; dibutyl sebacate; dibutyladipate; dioctyl adipate; dioctyl phthalate; dioctyl terephthalate; tributoxyethyl phosphate; butylphthalybutyl glycolate; dibutoxyethyl phthalate; 2-ethylhexyldipenyl phthalate; and dibutoxyethoxyethyl adipate. Additional suitable compatibilizers include alkyl amides such as N,N-dimethyl oleamide and others including dibutoxyethoxyethyl formal; polyoxyethylene aryl ether; (2-butoxyethoxy) ethyl ester of mixed dibasic acids; and dialkyl diether glutarate. A preferred compatibilizer is dibutoxyethoxyethyl adipate (SP value: 8.7).

Preferred compatibilizers are those having sufficiently low vapor pressures such that little or no evaporation occurs when heated during the fusing process. Such compatibilizers have boiling points of at least about 300° C., and preferred compatibilizers have boiling points of at least about 375° C.

One group of preferred compatibilizers comprises difunctional or trifunctional esters. As used herein, these esters, also called “di-esters” and “tri-esters,” refer to multiple esterification of a di-acid or tri-acid with an alcohol or the multiple esterification of a mono-acid with a diol or triol or a combination thereof. The governing factor is the presence of a multiple ester linkages.

Useful compatibilizers in this group include such compatibilizers as dibutoxyethoxyethyl formal, dibutoxyethoxyethyl adipate, dibutyl adipate, dibutyl phthalate, dibutoxyethyl phthalate, 2-ethyhexyl diphenyl phthalate, diethyl phthalate, dialkyl diether glutarate, 2-(2-butoxyethoxy) ethyl ester of mixed dibasic acids, triethyl citrate; tri-n-butyl citrate, acetyltriethyl citrate, dipropylene glycol dibenzoate, propylene glycol dibenzoate, diethylene/dipropylene dibenzoate, and the like.

The above compatibilizer can adjust the 75 degrees specular gloss of the toned image in a relatively wide range between 25% and 95% depending on the amount of the compatibilizer added. Thus, the image-recording sheet of the present invention can have a desired degree of gloss in accordance with the amount of the compatibilizer added. In general, the compatibilizer is contained in the recording layer in an amount of 1 to 25 wt. parts per 100 wt. parts of the recording layer. When the amount of the compatibilizer is less than 1 wt. part, the toners are insufficiently melted so that the intended degree of gloss cannot be attained. When the amount of the compatibilizer exceeds 25 wt. parts, blocking of the sheets may occur.

In the present invention, the image-recording layer is preferably exposed to a smoothing treatment so that the images with better quality can be formed on the layer. When the image-recording layer is smoothed, the gloss difference between the toner-fixed area and the toner-unfixed area on the layer can be decreased to prevent any gloss unevenness. In general, the smoothing treatment may be carried out by calendaring so that the image-recording layer has a 75 degrees specular gloss of 25% to 95%.

The image-recording sheet of the present invention can be produced by a conventional method as described below.

At first, the white pigment, the aqueous binder resin and the compatibilizer in a specific ratio are added to water or a polar solvent such as alcohol to obtain a coating composition. If necessary, the coating composition may contain various additives which are usually added to a pigment for coated paper such as a dispersant, a thickening agent, etc. The coating composition is coated on at least one surface of the paper substrate in an amount such that the above-described dry weight is attained. Then, the polar solvent is evaporated to form the image-recording sheet having the image-recording layer. Thereafter, the image-recording layer may be subjected to the smoothing treatment such as calendaring to prevent the uneven gloss as described above.

The present invention has been explained by making reference to the embodiments, but the present invention is not limited to those embodiments insofar as the functions and effects of the invention are not impaired. For example, the aqueous binder resin may be used in the form of an emulsion or a latex.

### EXAMPLES

Hereinafter, the present invention will be illustrated by the following examples. However, a person skilled in the art can readily understand that the present invention is not limited to these examples.

### Example 1

In this example, a coating composition was prepared by mixing the respective components shown in Table 1.

TABLE 1

| Component | Parts by Weight |
|---|---|
| Kaolin (pigment; ASP-170 available | 15.07 |
| from Tsuchiya Kaolin | |
| Industries) | |
| Calcium carbonate (pigment; | 15.07 |
| Brilliant 15 available from | |
| Shiraishi Calcium) | |
| Aqueous polyurethane dispersion | 12.92 |
| (aqueous binder resin; Sancure 776 | |
| available from Gunze Industries; | |
| Solid content: 35 wt. %) | |
| Polysodium carboxylate (dispersant; | 0.14 |
| ARON T-40 available | |
| from TOAGOSEI) | |
| Tributoxyethyl phosphate (compatibilizer; | 5.28 |
| TBXP available from Daihachi | |
| Chemical) (SP value: 8.6) | |
| Isopropanol | 3.63 |
| Deionized water | 47.11 |

The coating composition was coated using a Mayer bar on both surfaces of a paper substrate (Soft Glossy Paper C4179B available from Hewlett-Packard) to a dry coating amount of 8.0 g/m² on each surface. After that, together with the paper substrate, the coating composition was heated to about 100° C. to remove isopropanol and water to form an image-recording layer. The image-recording layer was calendered to smooth the layer yielding an image-recording sheet.

The 75 degrees specular gloss of this image-recording sheet was measured with a gloss-meter (VGS-ID manufactured by Nippon Denshoku Kogyo). A full color toned solid image was printed in on the image-recording sheet using a color laser printer (Color Laser Shot LBP-2040 manufactured by Canon) and then the 75 degrees specular gloss of the sheet was again measured.

Separately, the image-recording sheet was allowed to stand in an atmosphere of 20±2° C. and 65±5% RH for 24 hours or more. Then, a full color toned solid image was printed with the same laser printer on the image-recording layer. The appearance of the printed sheet was visually observed to check the formation of blisters.

### Example 2

In this example, an image-recording sheet was produced and evaluated in the same manner as in Example 1 except that a coating composition prepared from the components shown in Table 2 was used.

TABLE 2

| | Parts by |
|---|---|
| Component | Weight |
| Kaolin (pigment; ASP-170 available from Tsuchiya Kaolin | 6.03 |
| Industries) | |
| Calcium carbonate (pigment; Brilliant 15 available from | 24.11 |
| Shiraishi Calcium) | |
| Aqueous polyurethane dispersion (aqueous binder resin; | 13.70 |
| NeoRex R-960 available from Abicia; | |
| Solid content: 33 wt. %) | |
| Polysodium carboxylate (dispersant; ARON T-40 available | 0.14 |
| from TOAGOSEI) | |
| Di(butoxyethoxyethyl) adipate (compatibilizer; BXA available | 5.28 |
| from Daihachi Chemical) (SP value: 8.4) | |
| Isopropanol | 3.63 |
| Deionized water | 47.11 |

### Example 3

In this example, an image-recording sheet was produced and evaluated in the same manner as in Example 1 except that a coating composition prepared from the components shown in Table 3 was used, Pearl Coat (manufactured by Mitsubishi Paper Mills; basis weight: 127.9 g/m²) was used as a paper substrate, and the dry coated weight of the coating composition was 13.3 g/m² on each surface.

TABLE 3

| | Parts by |
|---|---|
| Component | Weight |
| Kaolin (pigment; ASP-170 available from Tsuchiya Kaolin | 3.01 |
| Industries) | |
| Calcium carbonate (pigment; Brilliant 15 available from | 27.13 |
| Shiraishi Calcium) | |
| Aqueous polyurethane dispersion (aqueous binder resin; | 12.97 |
| Sancure 776 available from Gunze Industries; Solid content: | |
| 35 wt. %) | |
| Polysodium carboxylate (dispersant; ARON T-40 available | 0.14 |
| from TOAGOSEI) | |
| Di(butoxyethoxyethyl) adipate (compatibilizer; BXA available | 5.28 |
| from Daihachi Chemical) (SP value: 8.4) | |
| Isopropanol | 3.63 |
| Deionized water | 47.11 |

### Example 4

In this example, an image-recording sheet was produced and evaluated in the same manner as in Example 1 except that a coating composition prepared from the components shown in Table 4 was used, and the dry coated weight of the coating composition was 2.7 g/m² on each surface.

TABLE 4

| | Parts by |
|---|---|
| Component | Weight |
| Kaolin (pigment; ASP-170 available from Tsuchiya Kaolin | 15.66 |
| Industries) | |
| Calcium carbonate (pigment; Brilliant 15 available from | 15.66 |
| Shiraishi Calcium) | |
| Aqueous polyurethane dispersion (aqueous binder resin; | 13.42 |
| Sancure 776 available from Gunze Industries; Solid content: | |
| 35 wt. %) | |
| Polysodium carboxylate (dispersant; ARON T-40 available | 0.15 |
| from TOAGOSEI) | |
| Di(butoxyethoxyethyl) adipate (compatibilizer; BXA available | 3.92 |
| from Daihachi Chemical) (SP value: 8.4) | |
| Isopropanol | 1.54 |
| Deionized water | 49.65 |

### Comparative Example 1

In this comparative example, an image-recording sheet was produced and evaluated in the same manner as in Example 1 except that a coating composition prepared from the components shown in Table 5 was used.

TABLE 5

| | Parts |
|---|---|
| Component | by Weight |
| Kaolin (pigment; ASP-170 available from Tsuchiya Kaolin | 17.36 |
| Industries) | |
| Calcium carbonate (pigment; Brilliant 15 available from | 17.36 |
| Shiraishi Calcium) | |
| Aqueous polyurethane dispersion (aqueous binder resin; | 14.88 |
| Sancure 776 available from Gunze Industries; Solid content: | |
| 35 wt. %) | |
| Polysodium carboxylate (dispersant; ARON T-40 available | 0.16 |
| from TOAGOSEI) | |
| Isopropanol | 4.16 |
| Deionized water | 46.08 |

### Comparative Example 2

In this comparative example, an image-recording sheet was produced and evaluated in the same manner as in Example 1 except that a coating composition prepared from the components shown in Table 6 was used.

TABLE 6

| | Parts by |
|---|---|
| Component | Weight |
| Aqueous polyurethane dispersion (aqueous binder resin; | 39.56 |
| Sancure 776 available from Gunze Industries; Solid content: | |
| 35 wt. %) | |
| Di(butoxyethoxyethyl) adipate (compatibilizer; BXA available | 16.15 |
| from Daihachi Chemical) (SP value: 8.4) | |
| Isopropanol | 13.33 |
| Deionized water | 30.95 |

The recording sheets produced in Examples 1-4 and Comparative Example 1 had the 75 degrees specular gloss (unit: %) shown in Table 7.)

TABLE 7

| | | Yel- | Ma- | | | | | White |
|---|---|---|---|---|---|---|---|---|
| | Black | low | genta | Cyan | Red | Green | Blue | Paper |
| Ex. 1 | 58.2 | 42.3 | 33.4 | 26.5 | 39.1 | 40.1 | 34.5 | 47.1 |
| Ex. 2 | 54.4 | 40.4 | 34.8 | 29.3 | 40.7 | 38.9 | 34.3 | 48.1 |
| Ex. 3 | 64.5 | 51.5 | 51.7 | 36.7 | 52.1 | 44.8 | 49.9 | 57.1 |
| Ex. 4 | 55.9 | 39.8 | 32.4 | 25.7 | 37.3 | 39.2 | 33.2 | 54.1 |
| C. Ex. 1 | 35.8 | 31.9 | 30.1 | 19.6 | 36.5 | 36.7 | 30.7 | 46.4 |

From the results in Table 7, the recording sheets of Examples according to the present invention increase the gloss in the imaged areas and provide the images with high quality. With varying the compositions of the image-recording layer, the recorded images can have desired gloss.

The presence of blisters was checked with the recording sheets produced in Examples 1-4 and Comparative Examples 1-2. The results are reported in Table 8.

TABLE 8

| | Presence of Blisters |
|---|---|
| Example 1 | No |
| Example 2 | No |
| Example 3 | No |
| Example 4 | No |
| Comparative Example 1 | No |
| Comparative Example 2 | Yes |

From the results in Table 8, no blister was formed in the recording sheets of Examples according to the present invention. Thus, the image-recording sheet of the present invention can provide color toned images with high quality without the formation of blisters.

1. An image-recording sheet comprising a paper substrate and an image-recording layer formed on at least one surface of the paper substrate, wherein said image-recording layer comprises:
a white pigment,
an aqueous binder resin, and
a compatibilizer,

2. The image-recording sheet according to claim 1, wherein said white pigment is at least one pigment selected from the group consisting of kaolin, heavy calcium carbonate, precipitated calcium carbonate, barium sulfate, titanium dioxide, titanium white, talc and plastic pigments.

3. The image-recording sheet according to claim 1, wherein said white pigment has an average particle size of 0.01 to 2 μm.

4. The image-recording sheet according to claim 1, wherein said aqueous binder resin is at least one resin selected from the group consisting of polyurethane resins, polyester resins, styrene, butadiene resins, styrene, acrylate resins and acrylic resins.

5. The image-recording sheet according to claim 1, wherein said compatibilizer has a solubility parameter of 8.0 to 10.0.

6. The image-recording sheet according to claim 1, wherein said image-recording layer is subjected to a smoothing treatment.

7. The image-recording sheet according to claim 6, wherein said image-recording layer has a 75 degrees specular gloss of 25 to 95%.

8. The image-recording sheet according to claim 1, wherein said compatibilizer has a melting point of at least about 300° C.

9. The image-recording sheet according to claim 1, wherein said compatibilizer is selected from the group consisting of dibutoxyethoxyethyl formal, dibutoxyethoxyetcyl adipate, dibutyl adipate, dibutyl phthalate, dibutoxyethyl phthalate, 2-ethyhexyl diphenyl phthalate, diethyl phthalate, dialkyl diether glutarate, 2-(2-butoxyethoxy)ethyl ester of mixed dibasic acids, triethyl citrate, tri-n-butyl citrate, acetyltriethyl citrate, dipropylene glycol dibenzoate, propylene glycol dibenzoate, and diethylene/dipropylene dibenzoate.
